(19) United States
(12) Patent Application Publication
(10) Pub. No.: US 2024/0056444 A1
(43) Pub. Date: Feb. 15, 2024

(54) SYSTEM AND METHOD FOR GENERATING A CONNECTION

(71) Applicant: Peter CORNELL, Beverly Hills, CA (US)

(72) Inventor: Peter CORNELL, Beverly Hills, CA (US)

(21) Appl. No.: 18/494,294

(22) Filed: Oct. 25, 2023

Related U.S. Application Data
(63) Continuation-in-part of application No. 17/395,047, filed on Aug. 5, 2021, now Pat. No. 11,838,962.
(60) Provisional application No. 63/061,496, filed on Aug. 5, 2020.

(51) Int. Cl. H04L 9/40

(52) U.S. Cl. CPC H04L 63/0869; H04L 63/101

(57) ABSTRACT

A computer system for forming connections is disclosed herein. The computer system can include a server in communication with a first computing device and a second computing device over a network. A connect request can be received from a first computing device. A connect request can be received from a second computing device.

### CROSS REFERENCE PARAGRAPH

This application is a continuation-in-part of U.S. patent application Ser. No. 17/395,047, filed on Aug. 5, 2021, which claims benefit of provisional application of U.S. Application No. 63/061,496, filed on Aug. 5, 2020, all of which are incorporated by reference in their entireties for all purposes.

### TECHNICAL FIELD

The present disclosure relates to a system for establishing a connection and/or exchanging information between users in a computer system.

### BRIEF DESCRIPTION OF THE DRAWINGS

FIG. 1 illustrates a hardware structure of an example computing system in accordance with some embodiments of the present disclosure.

FIG. 2 illustrates an example functional diagram of a connect system according to some embodiments of the present disclosure.

FIG. 3 is a flowchart illustrating an example process to provide connection services in accordance with some embodiments of the present disclosure.

FIG. 4A depicts an illustrative user interface for a connect system in accordance with some embodiments of the present disclosure.

FIG. 4B depicts an illustrative user interface for viewing historical connection information in accordance with some embodiments of the present disclosure.

FIGS. 5A-5C depict illustrative user interfaces for posting a connection in accordance with some embodiments of the present disclosure.

FIGS. 6A-6C depict illustrative user interfaces for finding a connection in accordance with some embodiments of the present disclosure.

FIGS. 7A-7D depict illustrative user interfaces for selecting a found connection in accordance with some embodiments of the present disclosure.

FIGS. 8A-8D depict illustrative user interfaces for accepting a connection in accordance with some embodiments of the present disclosure.

FIG. 9 depicts a flow chart illustrating user/system interaction in accordance with some embodiments of the present disclosure.

FIGS. 10A-10B depict an illustrative user interface for capturing a gesture in accordance with some embodiments of the present disclosure.

FIG. 11A depicts example code for loading a gesture model and handling an image stream in accordance with some embodiments of the present disclosure.

FIG. 11B depicts example code for identifying a user's hand for gesture recognition in accordance with some embodiments of the present disclosure.

FIG. 12 is a block diagram of an example computing device in accordance with some embodiments of the present disclosure.

### DETAILED DESCRIPTION OF THE DISCLOSURE

In accordance with some embodiments of the present disclosure, there is provided a computing system including a server executing a connect application in communication with a first computing device and a second computing device over a network. The server may include a processor and a memory storing the connect application user information. The executable instructions may be executed to cause the processor to receive a connect request from a first computing device comprising the connect application and operated by a first user over a network. The connect request may include a description and/or image of the first user and information which may indicate that the first user made a physical gesture to the second user. The physical gesture is made to signal that the first user is interested in connecting with the second user. The connect request may include information indicating first user location and time information relating to when the physical gesture was made. The executable instructions may be executed to cause the processor receive a connect request inquiry from a second computing device operated by a second user over the network. The connect request inquiry may include second user location and time information relating to when the physical gesture was made, and information indicating that the second user wishes to know more information about the connect request. The executable instructions may be executed to cause the processor to determine whether the first user location and time information match the second user location and time information. The executable instructions may be executed to cause the processor to: responsive to a determination that the first user location and time information coincides with the second user location and time information, and enable the second user to view the connect request from the first user to determine if the connect request was meant for the second user.

Thus, embodiments provide a way for users to discreetly and/or securely establish a connection based on encountering each other in a physical location whilst maintaining distance, e.g. without needing to closely approach, exchange details and/or speak to each other. Gesture recognition may be used to automatically launch the connect app and/or make a connection request from the first user. The request may automatically comprise location information (e.g., from GPS or similar mobile device location services) and time information. Similarly, the connect request inquiry from the second user may be automatically generated via gesture recognition of a gesture made in response by the second user and comprise location information (e.g., from GPS or similar mobile device location services, and time information. Alternatively, the second user may have to authenticate that they were at that location in other ways. This may help avoid people who are misusing the app. Predetermined rules may be implemented by the software to determine when a connection request is to be allowed and sensitive information exchanged between the users. For instance, a connection request may be allowed or made visible to the second user where the time and/or location match closely (i.e., within a predetermined limit). For example, a threshold time and location can be used (e.g., within 15 minutes and/or a 500-meter radius, etc.). Pending connection requests may be made invisible to a second user where there is not a match. Further matching may be performed (e.g., based on a physical description of the first and/or second users). The second user may then choose whether or not to accept the connection request. Thus, the system may help ensure that only connection request between the intended users are allowed leading to a connection and exchange of information (e.g., contact details, social media connections, etc.). The system may also be configured to take different action according to whether or not a unique match is found. Thus, if a unique match is found (e.g., based on location and time) the second user may immediately be permitted to see details of the first user and choose to connect, whereas if more than one match is found, then further matching may be performed and/or the second user may be permitted to see a message associated with the connection requests to give more information as to which connection request was directed to the second user, before allowing the connection.

Thus, a connect app and/or social media feature provides a computerized platform that may enable strangers who are at the same physical location, discreetly connect if desired on the app or social media feature via the initiator or “tagger” making a physical gesture (e.g., showing a peace sign then closing the fingers to form a 1 from the 2, etc.), leaving or sending a token, or verbally informing the “tagged” which indicates they would like the other to connect on the app or the social media feature.

In some embodiments, the application server may accept a connect request answer from the second user. The connect request answer may include contact information for the second user, such as email, phone number, app username, AppChat username, Facebook, dating site, etc. The application server may send the connect request answer from the second user to the first user.

In some embodiments, upon receiving a request from the second user, the application server may allow the first user to communicate with the second user.

In some embodiments, the application server may enable the second user to view a profile associated with the first user.

In some embodiments, the application server may enable the second user to view social network information and/or dating network information associated with the first user.

In some embodiments, the social network information may include information from Facebook, Twitter, Instagram, or LinkedIn, or any combination thereof.

In some embodiments, the first user may not be notified that the second user has viewed the first user connect request until the second user engages with the first user.

In some embodiments, the first user may be notified that the second user has viewed the first user connect request.

In some embodiments, the connect request may be associated with the first user is removed after a predetermined period of time. The connect request may include a personal note from the first user to the second user. The location and time information may be displayed on the connect application as a pin. The physical gesture may be an ear tug, an L shape gesture made with a pointer finger and a thumb, a temple tap, or any other gesture, or any combination thereof.

The connect request answer from the second user may include an image of the second user. The second user may provide image information and/or name information to the connect application to see the name and/or image of the first user.

In some embodiments, the connect application may use the second user's device to confirm the second user's location and time information. The second user may make the connect request inquiry at or near a matched location. A time machine feature may be enabled.

In accordance with some embodiments of the present disclosure, there is provided a computing system including a server executing a connect application in communication with a first computing device over a network. The server may include a processor and a memory storing the connect application user information and executable instructions. The executable instructions may be executed to cause the processor to automatically open the connect application upon detection of a first user physical gesture made by a first user, and accept a connect request from the first user on the first computing device. The connect request may include a description and/or image of the first user and information which may indicate that the first user made a physical gesture to a second user to signal that the first user is interested in connecting with the second user. The connect request may include information indicating a first user location and time information relating to when the physical gesture was made.

In some aspects of the disclosure, a computing system can be provided, which can comprise a server executing a social media and/or dating application in communication with a first computing device over a network, the first computing device having a connect option installed. The server can comprise a processor and a memory storing the connect option user information and executable instructions. The executable instructions can cause the processor to perform operations comprising: automatically opening, by the social media and/or dating application, the connect option upon detection of a first user physical gesture made by a first user; accepting a connect request from the first user on the first computing device, the connect request comprising: a description and/or image of the first user, information indicating the first user made the first physical gesture to the second user to signal that the first user is interested in connecting with the second user, and first user location and time information relating to when the first physical gesture was made.

In some embodiments, the connect request from the first user may be automatically generated upon detection of the first user physical gesture or a first user additional physical gesture from the first user.

In some embodiments, the first user physical gesture and the first user additional physical gesture may be a same type of gesture.

In some embodiments, the first user physical gesture and the first user additional physical gesture may be a different type of gesture.

In some embodiments, the first user physical gesture and/or the first user additional physical gesture may be chosen by a connect application administrator and/or the first user.

In some embodiments, the connect application may generate the connect request on a social media platform associated with the first user.

In some embodiments, the connect application may accept changes and/or additions to the connect request from the first user.

In some embodiments, the executable instructions may be executed to cause the processor to receive a connect request inquiry from a second computing device operated by a second user over the network. The connect request inquiry may include second user location and time information relating to when the first physical gesture was made, and information indicating that the second user wishes to know more information about the connect request.

In some embodiments, the executable instructions may be executed to cause the processor to determine whether the first user location and time information match the second user location and time information. Responsive to a determination that the first user location and time information coincides with the second user location and time information, the executable instructions may be executed to cause the processor to enable the second user to view the connect request from the first user to determine if the connect request was meant for the second user.

In some embodiments, the executable instructions may be executed to cause the processor to open the connection application on a second computing device when a second user physical gesture is made by the second user.

In some embodiments, the first user physical gesture and the second user physical gesture may be a same type of gesture.

In some embodiments, the first user physical gesture and the second user physical gesture may be different types of gestures.

In some embodiments, the first user physical gesture and/or the second user physical gesture may be chosen by the first user and/or the second user.

In some embodiments, the connect application may accept changes and/or additions to the connect request inquiry from the second user.

In some embodiments, the connect request inquiry from the second user may be automatically generated upon detection of the second user physical gesture or a second user additional physical gesture from the second user.

In some embodiments, the second user physical gesture and the second user additional physical gesture may be a same type of gesture.

In some embodiments, the second user physical gesture and the second user additional physical gesture may be a different type of gesture.

In some embodiments, the second user physical gesture and/or the second user additional physical gesture may be chosen by a connect application administrator and/or the second user.

In some embodiments, the connect application may automatically generate the connect request inquiry on a social media platform and/or a dating platform associated with the second user.

Embodiments of the present disclosure describe techniques of utilizing a software application to generate connections for a plurality of users in social network system. Notifications as described herein, may be provided to a user through a dedicated user interface to the software application, a web interface to the software application, and/or push notifications.

The terms “social network,” “social media application,” and “dating application,” are used interchangeably herein and may refer to any application and/or website and/or system with a social and/or communication component.

People have become less comfortable with face-to-face interactions and more so introductions due to the overwhelming connectivity to social media and mobile devices. To address these issues, some embodiments of present disclosure provide connection services on a connect application for users to initiate connections by using physical gestures made in physical locations where they meet. The connect application (e.g., connect app) may allow users to make a connection and see if it turns into communication at the choice of the “tagged” person.

For example, in some aspects of the disclosure, people that do not know each other can be connected. A first person can make a physical gesture to a second user to signal that he/she is interested in connecting with the second user. First user location and time information relating to when the physical gesture was made can be used to connect the first user to the second user.

For example, a man can see a woman at Whole Foods and wish to know whether she is interested in knowing more about him and/or meeting him in person. The man can make a physical gesture (e.g., pull his ear) to indicate to the woman that she can go to a connect app (e.g., called the EarTag app) on a smart phone to find a connect request from him. The connect request can have information pulled using the smart phone about the location and time when the physical gesture was made. For example, a pin can be put on the connect app indicating when and where the connect request was made. The connect request can also have a message from the man to the woman, such as: “Tall man in red hat wishes to meet woman with Lab dog” or “Tall man in red hat wishes to meet woman with Lab dog outside Whole Foods Saturday morning around 10:15 AM.”

The woman can make a gesture back (e.g., an ear tug) to the man and/or the woman can go to the connect app on her smart phone and look for the connect request from the man. The woman can also put a pin on the connect app indicating when and where the man gestured to the woman and/or the woman can open the connect app and look for a connect request at the location and time the man gestured to the woman. The woman can submit a connect request response indicating that she wishes to connect with the man and/or wishes to know more information about the man.

The connect app can determine whether there are any matches for the location and time information that the man and woman have indicated. If there are any matches, the connect app will enable the woman to view the connect request from the man, and the woman can determine whether the connect request was meant for the woman. The woman can also determine whether she wishes to: connect with the man over the connect app; whether she wishes to know more about the man using info on the connect app; or wishes to connect with the man over a social media or dating app; or any combination thereof.

Some embodiments of the present disclosure may utilize a social network and/or dating application to automatically open a connect option for generating connections upon detection of a first user physical gesture made by a first user (e.g., initiator or “tagger”) and accept a connect request from the first user on the first computing device. The social network and/or dating application may receive a connect request inquiry from a second computing device operated by a second user over the network. The connect request inquiry may indicate that the second user wishes to know more information about the connect request.

In some embodiments, the connect app may connect users who may frequently visit the same places, identify and showcase all users who are using the connect app to connect or “tag” other users. Since not everyone wants to be known to be on any given dating app, the connect app may help make a discreet connection. By utilizing the connect app or integrated social media platforms, the “tagged” activities may not be identified by others on the app and allow a connection for a user who happens to be attempting to make the connection with someone the user meets at a specific location. Accordingly, the disclosed principles may provide a practical technological solution to make connections while keeping effective social distancing among the users in the social network system.

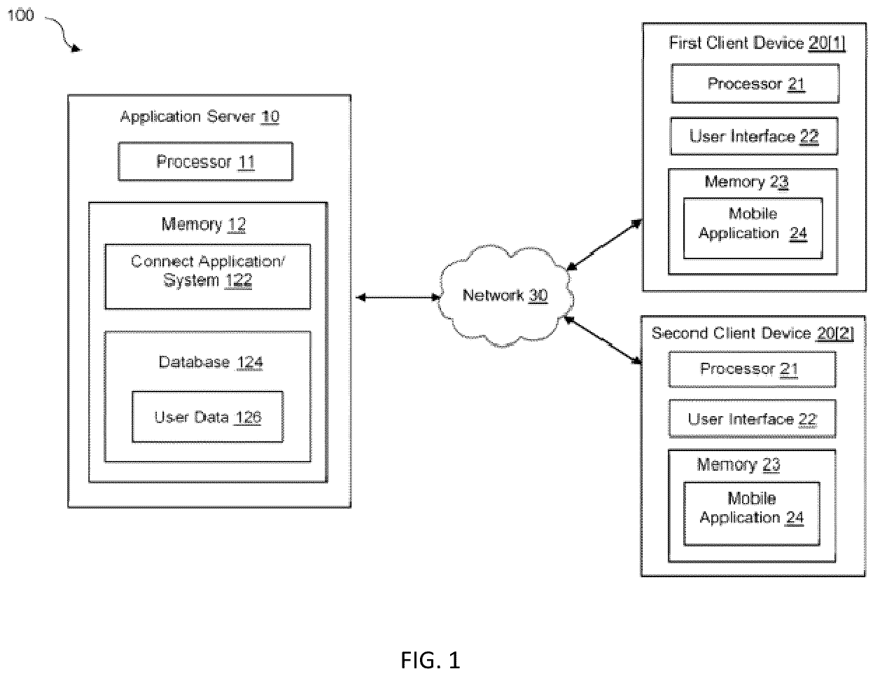

FIG. 1 illustrates an example computing system 100 configured to connect different social network accounts together to produce payment method probabilities and generate payment screen predictions. As illustrated, system 100 may include an application server 10 (e.g., a server computing device), one or more user computing devices 20 (e.g., computing devices or user devices each operated by a user). Application server 10 may include a processor 11, a memory 12 and a communication interface (not shown) for enabling communication between different computing devices over network 30. Application server 10 may be in communication with a plurality of computing devices 20 operated by users within a cloud-based or hosted environment over the network 30. For example, communication between the computing devices may be facilitated by one or more application programming interfaces (APIs). Network 30 may be the Internet or other public or private networks or combinations thereof.

Application server 10 may include one or more online applications including a connect application 122, a database 124, and other program modules which may be implemented in the context of computer-executable instructions and executed by application server 10. The one or more online applications may be executed by processor 11 for providing one or more computer-hosted services and/or providing websites with particular services for a user to visit via a browser running on a user computing device 20. Application server may host a social media platform with connect application 122 to provide online connection services for a plurality of users. A user may access an online connect service via a web browser or a mobile application 24 stored on a user mobile device 20. The online connect service may be any network 30 accessible service that may provide connection support for a plurality of users. As illustrated in FIG. 1, application server 10 is depicted as a single device for ease of illustration, but those of ordinary skill in the art will appreciate that application server 10 may be embodied in different forms for different implementations. For example, application server 10 may include a plurality of servers communicating with each other through network 30. Alternatively, the operations performed by application server 10 may be performed on a single server.

The connect application 122 and/or connect system 122 and/or connect feature may be linked to or communicate with or within one or more social networks, social media and/or dating applications such as Facebook, Twitter, X, Instagram, or Linked In, Tinder, Match, eHarmony, Grindr, or any other social network/social media/dating application/etc. (or web site or other system), or any combination thereof. For example, a signal (e.g., a gesture making an “F”, the sign language gesture for “F”, or any other gesture may be used to indicate that one wishes to connect on Facebook; a gesture making a “T” or “X”, or the sign language gesture for “T” or “X”, or any other gesture may be used to indicate that one wishes to connect on Twitter or X; a gesture making an “I”, or a sign language “I”, or any other gesture may be used to indicate that one wishes to connect on Instagram; and so on for any social network application, social media application, or dating application, or other application or website or other system, or any combination thereof. The connect application 122 may receive information from the social network, social media, or dating, or other application, or other website, or other system including information from any of these entities, or other similar entities, or any combination thereof. In some embodiments, the connect application 122 may be integrated into the social media network application, social media application, or dating application, or other application or website or other system. In further embodiments, the connect application 122 may function as a portal to the social media network application, social media application, or dating application, or other application or website or other system. For example, a connection formed using the connect application 122 may also share profile information on the social media application network application, social media application, or dating application, or other application or website or other system.

User computing devices 20 operated by a user may be any device configured to present user interfaces and receive inputs thereto. Each computing device 20[1] or 20[2] may be a smartphone, a personal computer, a tablet, a laptop computer, a personal digital assistant (PDA), or any computing system. A user may access the subscribed connect application provided by or hosted on application server 10 to perform social connection activities using a browser application through a computing device 20 or a mobile application 24 through a mobile device 20 operated by a user. A single user may have multiple computing devices 20, such as mobile phone, tablet, a smartphone, a personal computer, a tablet, a laptop computer, a personal digital assistant (PDA), or any computing system.

A user may create an account and subscribe to the connect application 122 provided by application server 10 or hosted on application server 10 in an online cloud computing environment. Each user account information or user profile may be stored as user data 126 in database 124. User data 126 may include user name, user identifier (ID), email address, phone number, the connect application user information, or other user account information to access to other social network websites (e.g., app username, AppChat username, Facebook, dating site).

Database 124 may be coupled to or in communication with the application server 10 via network 30. Database 124 may store user data 126, user connection data, and other data. Database 124 may receive instructions or data from and send data to application server 10. In some embodiments, the database 124 may be a shared remote database, a cloud database, or an on-site central database. In some embodiments, application server 10 may retrieve and aggregate a third party user data by accessing a social network or database via network 30. In one embodiment, application server 10 may store the retrieved user data 126 in database 124 for a predetermined period of time. User behavior data may include communication data between two or more users interacted with application server 10 through corresponding computing devices 20. User behavior data may be used for the connect application 122.

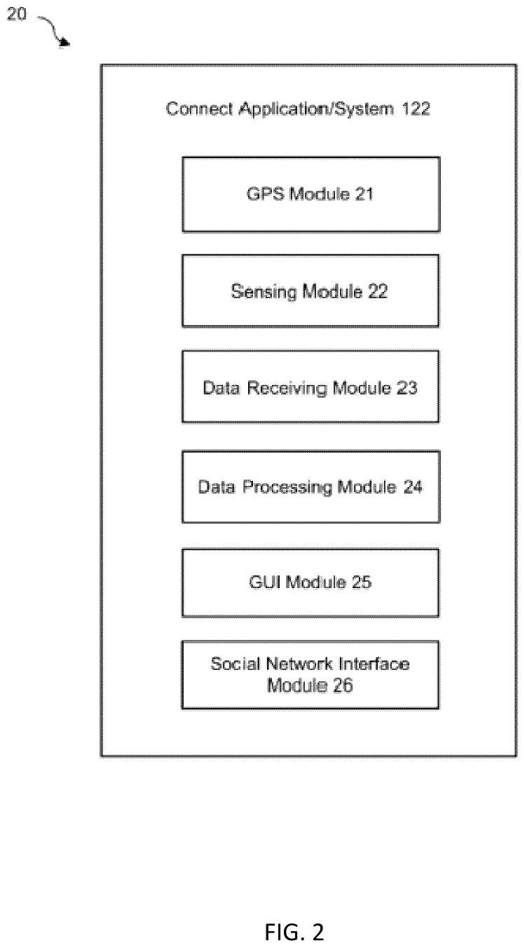

FIG. 2 illustrates an example functional diagram of a connect system/application according to some embodiments of the present disclosure. A plurality of modules may be constructed to facilitate a plurality of user connection or communication data with the connection system/application 122. The connection system/application 122 hosted on application server 10 may include a Global Positioning System (GPS) module 21, sensing module 22, data receiving module 23, data processing module 24, GUI module 25, and social network interface module 26. GPS module 21 may be executed to present a geographical map-based interactive user interface on a display of a user computing device 20 for a user to search or mark a location. GPS module 21 may be configured to identify and/or receive location and time that user activities happen. Sensing module 22 may be configured to detect user gestures. Data receiving module 23 and data processing module 24 may be configured to receive and process information or requests from the user computing devices 20 operated by users. GUI module 25 may be configured to present graphical user interfaces to receive user information and requests. Social network interface module 26 may be configured to link the connect app 122 to the social network web site.

Users may use and choose a plurality of different gestures to initiate connect request to build connections between users in a social network system, such as, but not limited to:
1) Touching nose with finger
2) Touching ear with finger
3) Tugging ear with finger and thumb
4) Touching side of eye with finger
5) Touching temple with finger or fingers
6) Touching forehead with finger
7) Touching top of head with finger or hand
8) Intertwining the index and middle finger from a “peace sign” (think “peace” to “fingers crossed”)
9) Bringing the index finger and middle finger together (think cutting gesture but pointed up)
10) Making a circle with your hand, thumb tip touches index tip and other 3 fingers are aligned with the index finger
11) Closed first with thumb on top, to a thumbs up
12) Horn gesture with the index and pinky finger extended, thumb holding down the middle and ring finger;
13) Circles in air with index finger
14) L with the right hand
15) Index finger and middle finger pointed to eyes, or
16) Index finger and middle finger pointed to eyes, then 180 degrees pointing to another person, or
17) Any combination of the above.

Gestures may further be used as an interaction method with the system itself. In some embodiments, gestures can be captured through a camera associated with the user computing device. The camera can be integrated to user computing device, or externally connected (e.g., an extended reality headset). In further embodiments, gestures can be captured as multi-touch inputs on touchscreen, or the like. For example, the system can be configured to interpret a multi-touch input based on gesture 9, referenced above, with the user's index and middle finger interfaced to the screen and respond in a similar manner as if the gesture was captured by a camera.

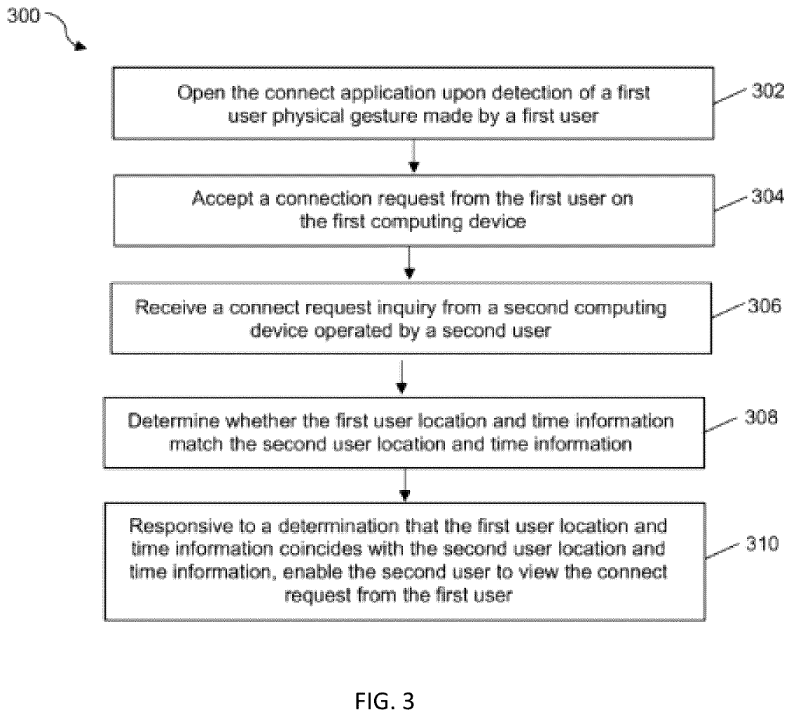

FIG. 3 is a flowchart illustrating an example process 300 to perform connection services to a plurality of users in a social network in accordance with some embodiments of the present disclosure. The process 300 may be configured as computer programs (e.g., connect application 122) executed on one or more computing devices, in which the systems, model components, processes, and embodiments described in the present disclosure can be implemented. Thus, the described operations may be performed with computer-executable instructions under control of one or more processors. The order in which the operations are described is not intended to be construed as a limitation, and any number of the described operations can be combined in any order and/or in parallel to implement the process.

At step 302, the application server 10 may execute a connect application 122 in communication with a first computing and automatically open the connect application upon detection of a first user physical device 20 gesture made by a first user. The first computing device 20 may store the connect application 122 and be operated by a first user over a network. In some embodiments, the application server 10 may automatically open a connect option by the social media and/or dating application, upon detection of a first user physical gesture made by a first user.

At step 304, the connect application may be executed to accept a connect request from the first user via a first user computing device. The connect request may include a description and/or image of the first user, and information which may indicate that the first user made a first physical gesture to the second user. The first physical gesture may be made by the first user to signal that the first user is interested in connecting with the second user, and first user location and time information relating to when the physical gesture was made. The connect application may automatically be opened upon detection of a first user physical gesture made by a first user operating the first computer device 20. The physical gesture to open the connect application may be same as or different from the one the first user makes to the second gesture. The connect application may automatically identify the first physical gesture associated with a GPS location information of the first user device when the first physical gesture was made. The first user may access a geographical map-based user interface presented by the connect application to search and mark a location (e.g., a first user location) or the time information when the physical gesture was made later after the first user has left the first user location. The first user may leave a “tag”, and/or generate a profile including a “Tag Line,” a social media link, a thumbnail picture, etc. The “Tag Line” may include a description of the first user, and information which indicates that the first user made a first physical gesture to the second user, etc. A user may access the connect application and edit the user profile by adding messages and marking the time and one or more places where the user has been. The user may define how long the message remains in the connection application.

In various embodiments, the connect request from the first user is automatically generated upon detection of the first user physical gesture or a first user additional physical gesture from the first user. The first user physical gesture and the first user additional physical gesture can be a same type of gesture or the first user physical gesture and the first user additional physical gesture can be different types of gestures. The first user physical gesture and/or the first user additional physical gesture can be chosen by a connect application administrator and/or the first user. In some embodiments, the connect application can generate the connect request on a social media platform associated with the first user. In some embodiments, the connect application can accept changes and/or additions to the connect request from the first user.

At step 306, the application server 10 may receive a connect request inquiry from a second computing device operated by a second user over the network. The connect request inquiry may include second user location and time information relating to when the physical gesture was made, and information indicating that the second user wishes to know more information about the connect request.

At step 308, the application server 10 may determine whether the first user location and time information match the second user location and time information. The connect application may present the connect request to the first user and the second user when a matched location is located an intersection of the first location and the second user location. The matched location (e.g., a Tag Spot or Tag Spot Area) may be within a predetermined radius of the intersection.

At step 310, responsive to a determination that the first user location and time information coincides with the second user location and time information, the application server 10 may enable the second user to view the connect request from the first user to determine if the connect request was meant for the second user. In some embodiments, the connection application may be opened on a second computing device when a second user physical gesture is made by the second user. The connect request inquiry from the second user is automatically generated upon detection of the second user physical gesture or a second user additional physical gesture from the second user.

In various embodiments, the first user physical gesture and the second user physical gesture may be a same type of gesture. The first user physical gesture and the second user physical gesture may be different types of gestures. The first user physical gesture and/or the second user physical gesture may be chosen by the first user and/or the second user. The connect request inquiry from the second user may be automatically generated upon detection of the second user physical gesture or a second user additional physical gesture from the second user. The second user physical gesture and the second user additional physical gesture may be a same type of gesture or the second user physical gesture and the second user additional physical gesture may be a different type of gesture. The second user physical gesture and/or the second user additional physical gesture may be chosen by a connect application administrator and/or the second user. The connect application automatically may generate the connect request inquiry on a social media platform and/or a dating platform associated with the second user.

In some embodiments, the application server 10 may accept a connect request answer from the second user. The connect request answer may include contact information for the second user, such as email, phone number, app username, AppChat username, Facebook, dating site, etc. The application server 10 may send the connect request answer from the second user to the first user.

In some embodiments, upon receiving a connect request inquiry from the second user, the application server 10 may allow the first user to communicate with the second user. The application server 10 may enable the second user to view social network information and/or dating network information associated with the first user.

In some embodiments, the social network information includes information from Facebook, Twitter, Instagram, or Linked In, or any combination thereof.

In some embodiments, the first user may not be notified that the second user has viewed the first user connect request until the second user engages with the first user. The first user may be notified that the second user has viewed the first user connect request.

In some embodiments, the connect request made by the first user may be removed after a predetermined period of time. The predetermined period of time may be defined by the first user. The connect request made by the first user may be removed automatically after the connection is established. The connect request may comprise a personal note from the first user to the second user. For example, the personal note may be simple description of the users such as “a Tall guy in black hat “ear tugged” girl in pink striped mask and white dress at Whole Foods at Noon on Saturday.” The personal note may be the only identifying information for the first user. The message may indicate that “ME ear tugged YOU” with the following descriptions:

ME: Tall man, brown hat, red shirt: YOU: Blond woman, white dress, red shoes. agree to share Facebook

In some embodiments, the connect request answer may include an image of the second user. The second user may provide image information and/or name information to the connect application to see the name and/or image of the first user. The second user may make the connect request inquiry at or near a matched location.

In some embodiments, the connect application may use the second user's device to confirm the second user's location and time information.

A time machine feature may be enabled. For example, the second user (e.g., a girl) may operate a second computing device to initiate the connect app if the second user remembered someone ear tugged her 2 weeks ago or indefinitely. The second user may have to authenticate that she was there; or next time that she went to that location, she may confirm she was there on the connect app. This may help avoid people who are misusing the app.

In some embodiments, a connection example described in process 300 may be validated and deployed into a practical application in a server-client computing environment of system 100. For example, the connect system/application 122 may be installed onto the user computing devices associated with a plurality of users to utilize connect services through a social network platform. The connect system/application 122 may be integrated with the platform to provide various graphical user interfaces displayed on a user interface of a computing device 140 when a user is interacting with the online social network platform over the network 30.

A connect app and/or social media feature may enable strangers who are at the same physical location, discreetly connect if desired on the app or social media feature via the initiator or “tagger” making a physical gesture (giving a gentle tug of the ear lobe, showing a peace sign then closing the fingers to be 1 from the 2, etc.), leaving or sending a token, or verbally informing the “tagged” which indicates they would like the other to connect on the app or the social media feature.

For example, John is sitting at a restaurant for a business dinner and sees a girl (who we will call Jane), across the room who he locks eyes with, and they continue to catch one another's eye throughout their respective meals. The girl is eating with her family, and rather than having John interrupt the girl's dinner, or creating an awkward situation, he gently tugs his ear lobe when they make eye contact yet again at the restaurant, indicating that she has been “tagged”. John goes to the connect app integrated social media platform of choice to send a connect request, and verifies his current location at the restaurant (e.g., Uber location for pick up) where it will remain for 24 hours. John can also mark his location later after he has left, and he leaves his “tag”, or a profile/thumbnail picture. Jane can go to the connect app integrated social media platform anytime and either mark her location there at the restaurant while she is there or she can mark her location at the restaurant later once she has left. Once she has marked the location, John's profile picture may come up, and a “Tag Line”, such as “Beautiful girl wearing a red dress eating with her family”, or “Red dress drinking red wine”. etc. Once identified, Jane may click on John's profile on the connect app or integrated social media platform(s) discreetly before ultimately deciding to engage in conversation or not.

John may never know Jane looked for him on the app or feature unless Jane ultimately decided to engage him. John's “Tag” gets deleted from the app after 24 hours, without a trace. Once Jane initiates contact in under 24 hours, John's tag gets deleted from the app immediately.

In various scenarios, the connection may be used in many situations and environments. For example, a connect application or other application can be used to connect with and/or find contact information for a person(s) a user sees at a place the user has been, such as, but not limited to, a concert, a bar, a gas station, or a store. As an additional example, a person may see someone in a car while they drive by, and one person (e.g., a driver or a pedestrian) can make a gesture (e.g., “ear tag”) to another person (who is in a car or on the street). In this example, the intersection (or a predetermined area near the intersection, e.g., a 0.5 mile radius) where the gesture was made may serve as a Tag Spot or Tag Spot Area. In some aspects of the disclosure, a person looking to connect (e.g., the instigator and/or the replying party) may need to have a GPS or location tracking information on their device (e.g., WIKI) indicating that they have been at the Tag Spot or Tag Spot Area. In some aspects, a person looking to connect (e.g., the instigator and/or the replying party) can send an image or other description information (e.g., “tall man in white hat wants to connect with girl in pink dress with puppy at Whole Foods on Jul. 7, 2020”) proving that the person was at the Tag Spot or Tag Spot Area.

In some embodiments, the gesture may use a “tag” only on another app or web site, such as a social media app (e.g., Instagram, Facebook, etc.) where a person could “Add Location” of where they currently are or were to a post of any sort, and/or “Tag” the location (e.g., a restaurant) so that the “tagger” may search by location and/or business or place to see if the “tagged” person posted on social media so the “tagger” can initiate contact with the other person.

Aspects of the present disclosure may establish a computer-implemented system and method to connect services for a large amount of users in various social network systems. By utilizing an application (e.g., connect app, social media app or website, other app or web site), strangers can connect discreetly after seeing one another in person, and after one, or both people, give or receive an initiating gesture/invite (e.g., called Gestvite in some embodiments, although many other names can be used) to indicate they can connect on an app.

In some aspects, the initiating gesture/invite (Gestvite) can be recognized by a capable mobile device to take the user directly to the connect app or other app (e.g., social media app) (opening the app) where they can choose whether to leave a “tag” or search for one. The “tag” can be accessed traditionally as well if a mobile device isn't capable of processing the “Gestvite”, or, the user would like to open the app discreetly.

In some aspects of the disclosure, one or both of the strangers can “tag” or identify themselves on the connect app or a social media app at their current location or at a point later in time to have a conversation initiated. The “tag” can be a “tagline”, and/or a user's picture set for the connect app. Social media links can be presented as well. Once the connection has been established, the identifying “tag” or “tags” from one or both strangers can disappear from the connect app or other app. If the connection isn't established, the user can choose when the “tag” will disappear.

In some aspects of the disclosure, people can check the connect app or other app (e.g., social media app) for missed connections at a place they frequent or have visited, with or without receiving a gesture/invite (Gestvite), which may be based on other users opting to let their “tag” remain at the particular location. For example, if a person doesn't have time to make a gesture, or doesn't think another person saw their gesture, a message can be posted that the other person can see. (Thus, a gesture doesn't need to be made in some aspects.) A person can search places she's been, or she can list places she's been. “Taggers” can choose how long a message remains. The message can be non-identifying except for descriptive details about the persons and the location (e.g., tall guy in black hat wants to meet girl with puppy in outside Whole Foods store on Sunday afternoon).

In some aspects of the disclosure, users can send videos to each other using their computing devices and the connect app and/or another app (e.g., a social media app, a dating app). In addition, the users can send videos and/or video call one another (e.g., using the connect app and/or another app) as a means of communication after connecting if they choose. In addition, after connecting (e.g., using the connect app or another app), the users can continue to keep communicating on the app they used to connect (e.g., the connect app or another app) or via another app or platform (e.g., a social media platform or a dating platform) once respectively connected.

An example algorithm for connecting users, according to embodiments of the present disclosure, is as follows:
Accepting system instructions: For example, accept instructions (e.g., from a system administrator and/or a first user) relating to required and optional information for connect request and required and optional information for connect request inquiry; accept instructions (e.g., from an administrator and/or a first user) regarding whether and when the first user is notified when the second user has viewed a connect request; accept instructions (e.g., from an administrator and/or a first user) regarding when a connect request is to be deleted; accept instructions regarding distance and/or time parameters; or accept any instructions regarding what gestures are recognized and what meaning they have; or any combination thereof.
Generate a connect request on the connect app or other app/system. The connect request may include: first user identifying information (e.g., a picture, a physical description (6 foot tall Caucasian man with brown hair and brown eyes), contact information, real name information, alias name information), first user location information when physical gesture to second user was made, time information (e.g., date and time information) relating to when the physical gesture to the second user was made, or optional information (e.g., custom message such as TALL MAN IN RED HAT WANTS TO CONNECT WITH GIRL IN GREEN DRESS, other information), or any combination thereof. The connect app and/or the connect request may be opened/generated by the first user using one or more gestures.
Generate a connect request inquiry on the connect app or other app/system. The connect request inquiry may include: second user identifying information (e.g., a picture, a physical description, contact information, real name information, alias name information), second user location information relating to when physical gesture was made by first user, time information relating to when the physical gesture to the second user was made, or information indicating that the second user wishes to know more information about the connect request (e.g., a custom note, a symbol, a word indicating the second user would like to know the real identification of the first user, would like to know more about the first user, or would like to meet the first user, or would like to connect through the connect app or another app), or any combination thereof. The connect app and/or the connect request inquiry may be opened/generated by the second user using one or more gestures.
Search connect requests on the connect app or other app/system to see if there are any connect requests that have GPS and time information that matches the connect request inquiry within a certain pre-set distance/radius (e.g., within ¼ mile) and a certain pre-set time (e.g., 15 minutes).
If only one match is found, display on the connect app or other app/system the first user identifying information of the matching connect request and/or any custom message to the second user and allow the second user to accept the connect request. (Additional information may also be shown.) If more than one match is found, allow the second user to view first user identifying information and/or custom messages for any matching connect requests to determine if any connect requests were meant for the second user and accept that request(s).
Notifying the first user when the second user has viewed the connect request in accordance with system parameters.
Accepting a communication request and a from the second user allowing communication with the first user after the second user chooses a match. The communication can be on the connect app or other app/system. The communication request may be initiated by a gesture.
Removing the connect request after a predetermined period of time in accordance with system parameters.

In some embodiments, the system can be configured to perform gesture recognition (e.g., via sensing module 22) to automatically recognize an initiating gesture/invite from a user and automatically launch or take an appropriate action in the connect app such as generate and/or respond to a connect request as described herein.

Gesture recognition is a topic in computer science and language technology with the goal of interpreting human gestures via mathematical algorithms. Gestures can originate from any bodily motion or state but commonly originate from the face or hand. Users can use simple gestures to control or interact with devices without physically touching them. Many approaches have been made using cameras and computer vision algorithms (e.g., to interpret sign language). However, the identification and recognition of posture, gait, proxemics, and human behaviors is also the subject of gesture recognition techniques. Gesture recognition can be seen as a way for computers to begin to understand human body language, thus building a richer bridge between machines and humans than primitive text user interfaces or even GUIs (graphical user interfaces).

Gesture recognition can be conducted with techniques from computer vision and image processing based on images/video captured by a camera (e.g. a single camera or stereo camera). These might for instance be captured by a smart phone, tablet or other mobile computing device that incorporates cameras belonging to the first user and/or second user to capture gestures made by the respective user. Other examples may use input from motion sensors such as inertial measurement units (IMUs) on mobile and small form-factor devices. On these devices, gesture sensing relies on users performing movement-based gestures capable of being recognized by these motion sensors. Similarly the motion sensors might be provided on wearable computing devices, i.e. their usage and interaction location takes place on the user's body. These might for instance be smart watches, smart rings, etc.

Depending on the type of the input data, the approach for interpreting a gesture could be done in different ways. However, most of the techniques rely on key pointers represented in a 3D coordinate system. Based on the relative motion of these, the gesture can be detected with a high accuracy, depending on the quality of the input and the algorithm's approach. The gesture is then classified according to common properties. Examples of suitable algorithms for interpreting gestures may include one or more of 3D model-based algorithms (e.g., using volumetric and/or skeletal models, appearance-based models that derive the parameters directly from the images or videos using a template database, electromyography-based models that study of electrical signals produced by muscles in the body, etc.).

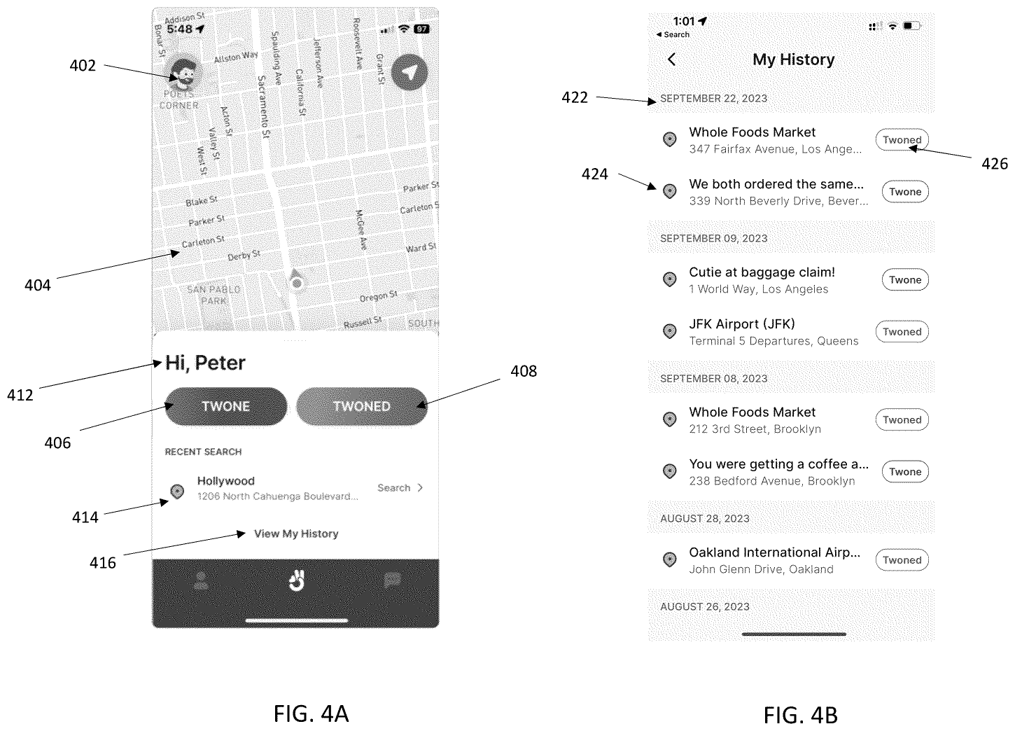

FIG. 4A depicts an illustrative user interface (UI) for a connect system in accordance with some embodiments of the present disclosure. The UI can display a variety of elements to the user. The UI can include a map 404 of a user's location. The location of the user can be based on some combination of GPS or network triangulation. In certain embodiments, the map 404 can be interactable, allowing the user to see nearby recent posts and/or pin locations for future posts or searches.

The UI can include information clarifying the current logged in user. For example, the UI can display the user's real name 412, account name, avatar 402, or a photo. In some embodiments, a user can choose to be visible in the application as an avatar prior to a connection. The avatar may share some generalized featured with the user (e.g., hair color) making it easier for other users to associate the avatar with the user after an encounter. In further embodiments, a user can choose to be visible as a photograph prior to a connection.

In some embodiments, the connect system can include both an avatar and an image of the user. The avatar may be generic, allowing the user to post without identifying themselves. The connect system may include options to anonymize portions of the UI (e.g., screens the user may access in more crowded areas) with non-identifying information (i.e., use the avatar vs a photo or a username vs real name).

In certain embodiments, the connect system may select different images based on the connection status and action of a user or users. For example, communications (e.g., posts) between unconnected users may be limited to avatars, while connected users may see real photos. In another embodiment, a user may share a photo in posting or replying to a post. In further embodiments, the photo may be a selfie to portray the user more accurately as they appeared at the time of the shared physical gesture.

The UI can include options to post 406 or search posts 408 to form connections.

In certain embodiments, the UI can provide historical connection information 414 associated with recent posts and/or searches. The UI can further include a button or link 416 to expanded historical connection information.

FIG. 4B depicts an illustrative user interface for viewing historical connection information in accordance with some embodiments of the present disclosure. The historical connection information can include entries 424 comprising some combination of posts, searches, specific search results, and/or overlooked connections. Each entry 424 can be labeled according to type (e.g., posts, searches, specific search results, and/or overlooked connections). The entries 424 can be sorted based on date 422 or type 426. In certain embodiments, the sorting method is customizable by the user. In some embodiments, entries 424 can be pinned by a user to appear in a prioritized portion of the UI (e.g., on top).

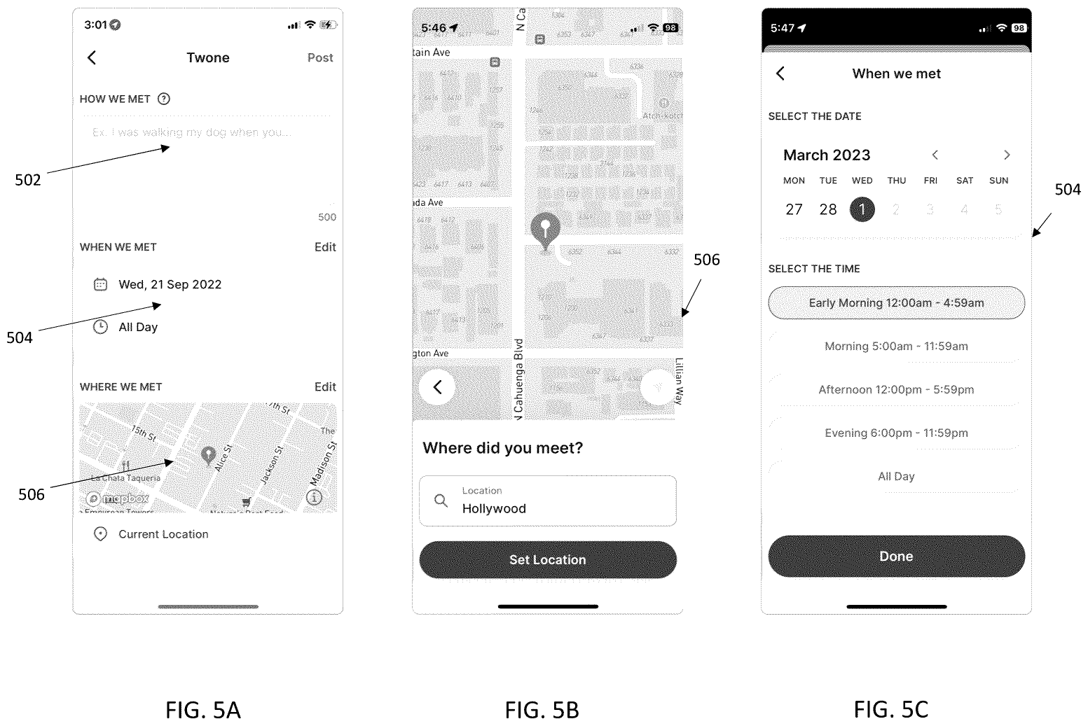

FIGS. 5A-5C depict illustrative user interfaces for posting a connection in accordance with some embodiments of the present disclosure. The UI can allow a user to enter information associated with a real-world encounter with another user. The information can include a description 502 of the encounter, a time 504 of the encounter (e.g., a time frame when the encounter occurred), and/or a location 506 of the encounter. The location 506 may be selectable using some combination of a map, the user's current location, or entering an address. In some embodiments, the system may limit a user to only post to locations within a range of where they have visited recently and/or at the selected time.

In certain embodiments, the connect system may store a log of historical searches. The log of historical searches can be provided, via the UI, to the user to allow them to perform the search again using the same search criteria information. The log can be provided to the user in order of time the search was made. Alternatively, or additionally, the connect system may include options to search the log based on a description of the encounter, a time of the encounter (e.g., a time frame when the encounter occurred), and/or a location of the encounter. In some embodiments, the entries in the log may be configured to expire after a predetermined time frame and/or if the user responds to a post based on the search.

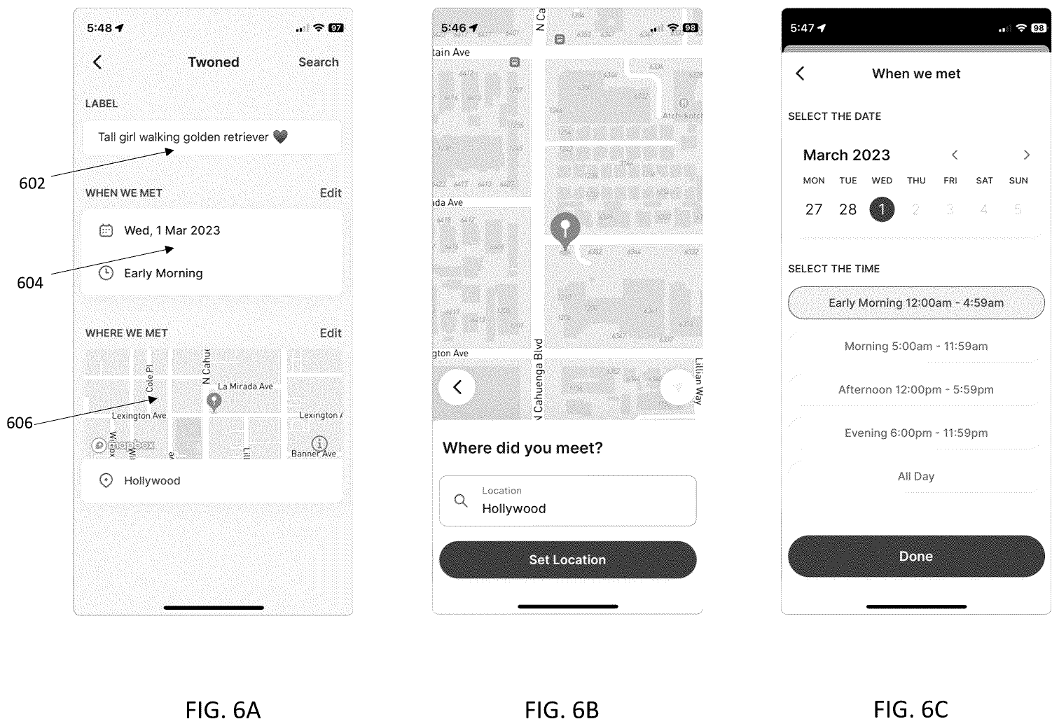

FIGS. 6A-6C depict an illustrative user interface for finding a connection in accordance with some embodiments of the present disclosure. The UI can allow a user to find posted information associated with a real-world encounter with another user. The UI can allow a user to search for the encounter based on the description of the encounter, time 604 of the encounter, and/or location 606 of the encounter. For example, a user may choose a location on a map and a time frame and read listed descriptions posted at the location until they find the description corresponding to their encounter. In some embodiments, searches may be further limited based on user preferences (e.g., orientation). The search can include features of the posting user (e.g., hair color).

In certain embodiments, when searching posts, posted location may be generalized for the security of the poster. For example, the posted location may only be accurate to a threshold distance from the actual location.

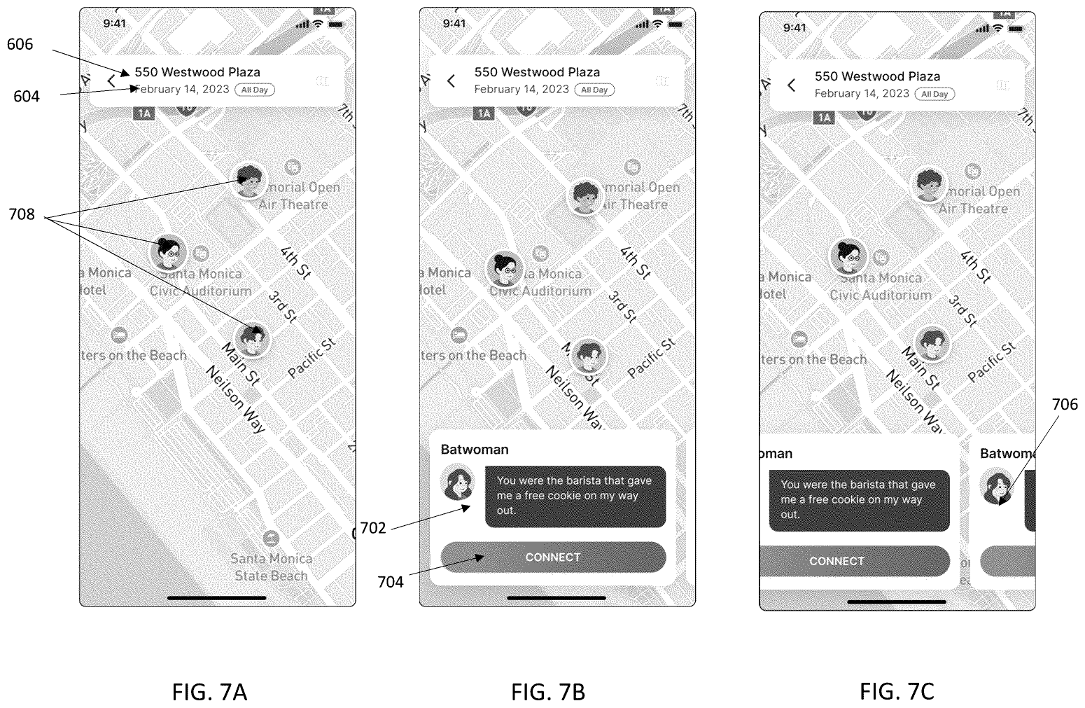

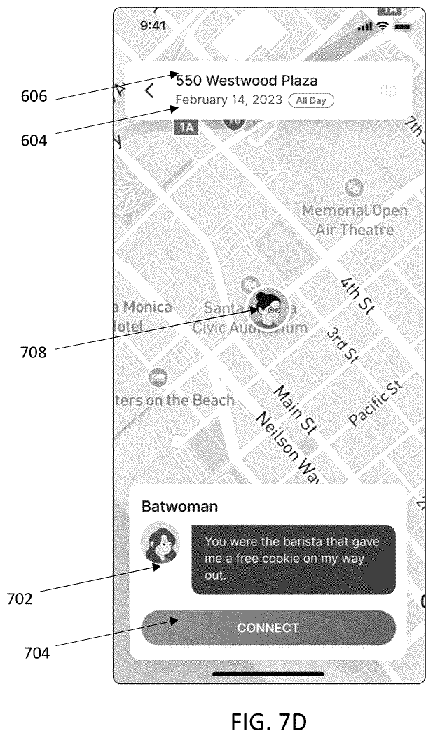

FIGS. 7A-7D depict illustrative user interfaces for selecting a found connection in accordance with some embodiments of the present disclosure. While performing a search, a user may be presented with posts 702 within a given distance of the searched location. In some embodiments, the user may select an avatar 708 associated with a post 702 to view the post 702. Alternative and/or additionally the user may search through a listing of posts 702. For example, the user may swipe in a direction to view additional posts 706. After locating the encounter, the UI can present an option to initiate a connection 704 with the posting user 702.

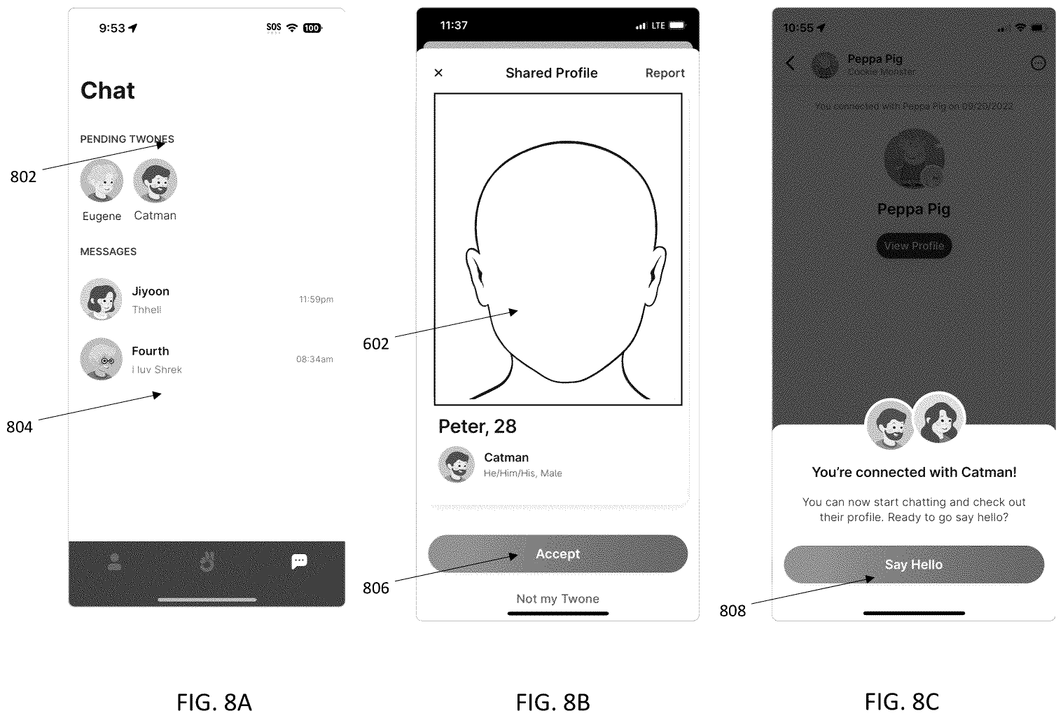

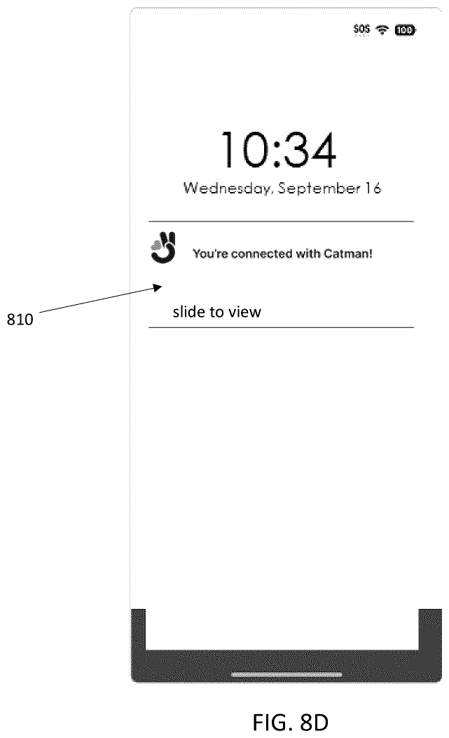

FIGS. 8A-8D depict an illustrative user interface for accepting a connection in accordance with some embodiments of the present disclosure. The UI can display pending connections 802 and active connections 804 (e.g., other users with which the user can see their full profile including actual photos 602 and/or communicate 808). In certain embodiments, the posting user can accept 806 a response to their post and share their profile. A push notification 810 can be generated to alert the users of the connection. Similar push notifications can be generated for any notification described herein.

In some embodiments, the system can include a machine learning algorithm trained on human faces, to verify that their profile photo is of an actual person. In further embodiments, the machine learning algorithm can be used to match the image to a provided identification (e.g., a driver's license. The machine learning algorithm can be trained on an external database of facial images and/or profile images collected by the system.

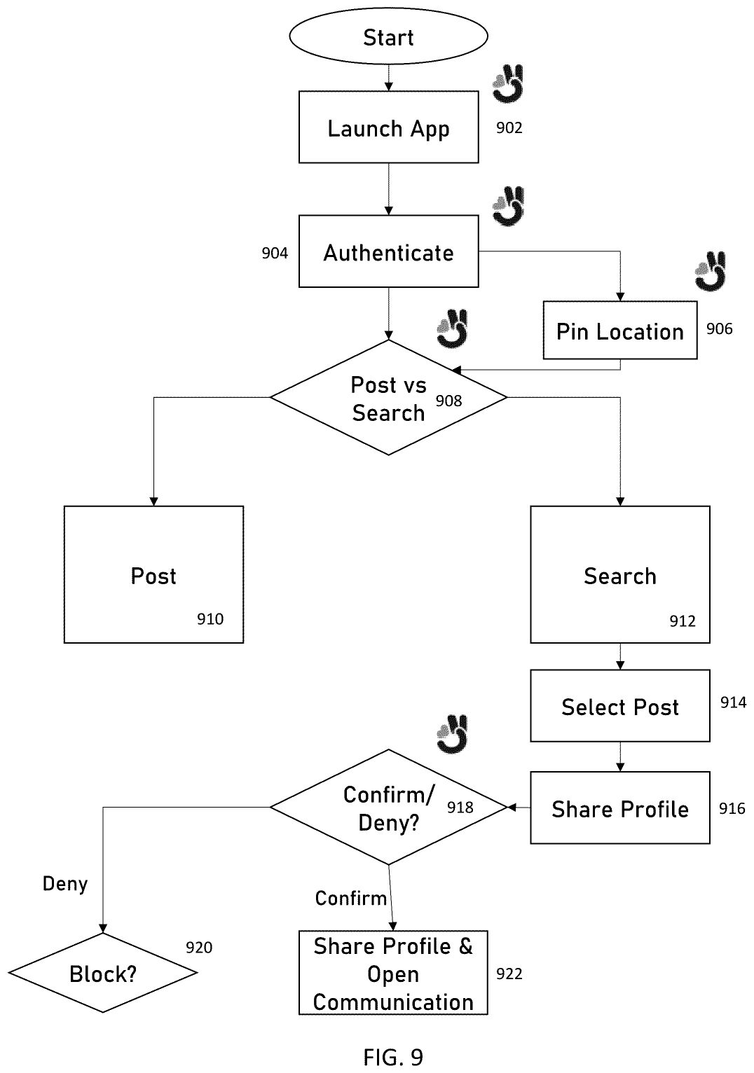

FIG. 9 depicts a flow chart illustrating user/system interaction in accordance with some embodiments of the present disclosure. A user may launch 902 the application. The application can be a dedicated application or run within an existing application (e.g., a web browser). In some embodiments, the user may launch 902 the application using one or more gestures, as described herein. The gesture can be recognized by some combination of a background service application and/or a camera application.

The system may prompt the user to authenticate 904 (i.e., login) their account. Authenticating 904 can include providing login credentials (e.g., a username and password) and/or two-factor authentication protocols as known in the art. In further embodiments, authentication 904 can include prompting the user to provide one or more gestures, as described herein.

In some embodiments, the system can provide users with a UI to pin 906 locations for future posts 910 or searches 912. In further embodiments, detecting one or more gestures, as described herein, can prompt the system to pin 906 the user's current location. For example, a first user may record a second user signaling with a gesture which automatically pins 906 the current location so the first user can later search 912 for a post 910 at said location by the second user.

As previously described in reference to FIG. 4, the system can provide a UI to allow a user to select 908 whether they wish to post 910 or search 912 following an encounter with another user. In some embodiments, the system can accept one or more gestures as input to select 908 the option of posting 910 or searching 912.

As previously described in reference to FIGS. 5A-5C, the system can provide a UI to allow a user to post 910 an encounter. In some embodiments, the post can be based on a previously pinned 906 location.

As previously described in reference to FIGS. 6A-6C, the system can provide a UI to allow a user to search 910 for a posted 910 encounter. In some embodiments, the search can be based on a previously pinned 906 location. Responsive to a searched post being selected 914, a user can share 916 their profile and request a connection.

The posting user may confirm or deny 918 the connection request. In some embodiments, the system accepts input of one or more gestures to confirm and/or deny requests. In response to confirming the connection request, both users can be granted access to each other's profiles, and a communication link can be opened 922. In response to denying the connection request, the request can be canceled. The user may be given the option to block 920 interaction (e.g., through posts, searches, and/or requests) with the user in the future. In some embodiments, after a predetermined period of time, the request may automatically lapse.

In some embodiments, a gesture can be automatically captured and used to trigger functionality as described herein. A gesture can be universally linked to triggering a specific function. Alternatively, a gesture can be linked to multiple functions in response to other operations by the user (e.g., the current interface selection and/or a recent action by the user). For example, performing a given gesture at the interface illustrated in FIG. 4 may automatically pin the user's current location. In some embodiments, the user may be prompted to perform a gesture to trigger certain functionality.

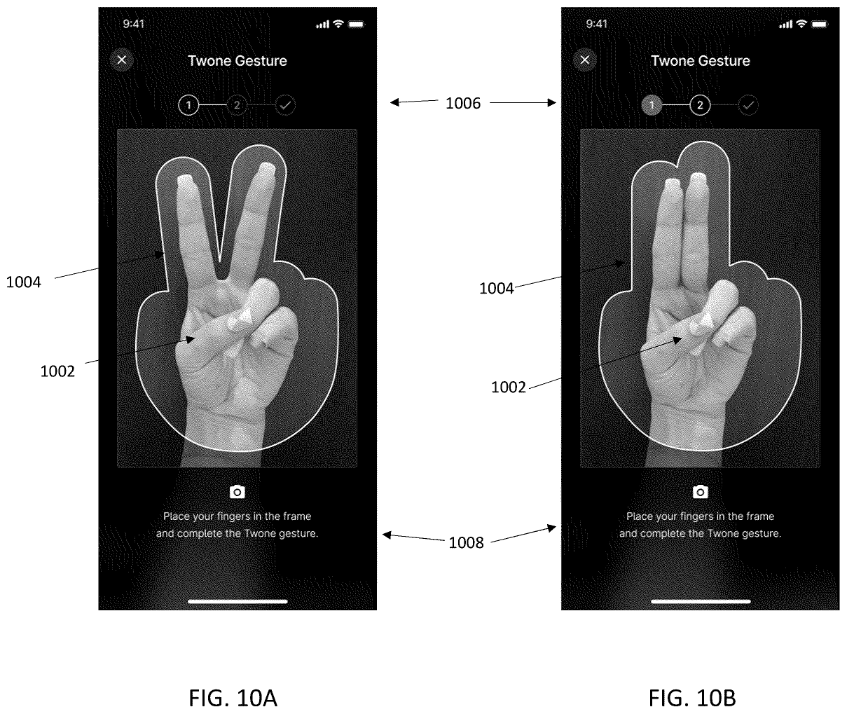

FIGS. 10A-10B depict an illustrative UI for capturing a gesture in accordance with some embodiments of the present disclosure. The UI can include a video or images 1002 captured of the user. The UI can include visual 1004 and/or textual 1008 prompts for performing the gesture. The visual 1004 and/or textual 1008 prompts may be updated as the system recognizes the user performing steps of the gesture. Alternatively, the visual 1004 and/or textural prompts 1008 prompts can be animated to illustrate the gesture to the user. In some embodiments, the UI can include confirmation 1006 of the user performing a step of the gesture.

In some embodiments, the gesture used to initiate functionality in the application is the same gesture as used to initiate a connection request. Repeated usage of the gesture within the application may reinforce the social usage of the gesture.

In some embodiments, a user may be able to present a digital representation of the gesture, similar the UI presented in FIGS. 10A-10B on the device's display. The digital representation of the gesture may be animated. For example, a user first may prompt the application to display the digital gesture and face their screen at a second user (i.e., as a substitute for physically performing the gesture). In certain embodiments, the second user may capture the digital representation of a gesture using the application to automatically initiate functionality within the application. For example, the second user may capture the digital gesture displayed by the first user, and the current location may be automatically pinned. In certain embodiments, the digital representation may include a unique identifier (e.g., a QR code) which when captured by a second user can automatically connect or provide a connect request to one or both of the two users.

The example gesture depicted in FIGS. 10A-10B is bringing the index finger and middle finger together.

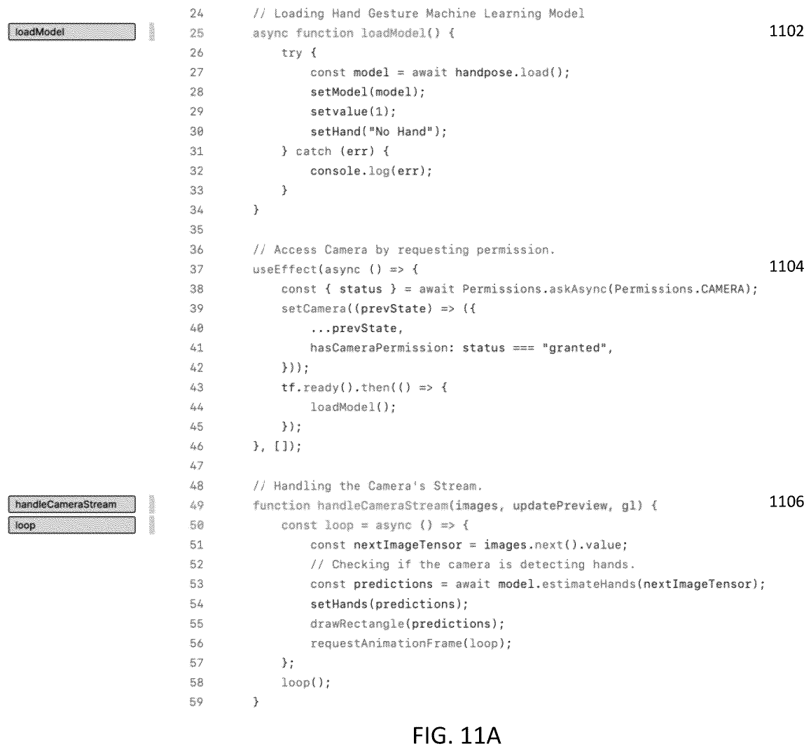

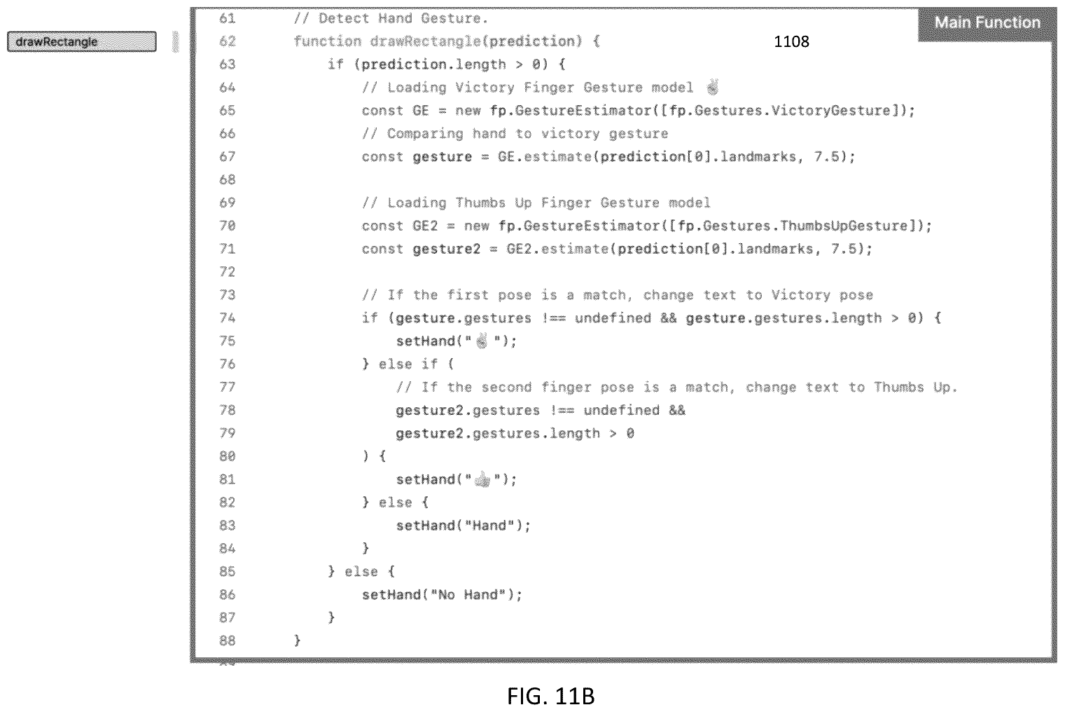

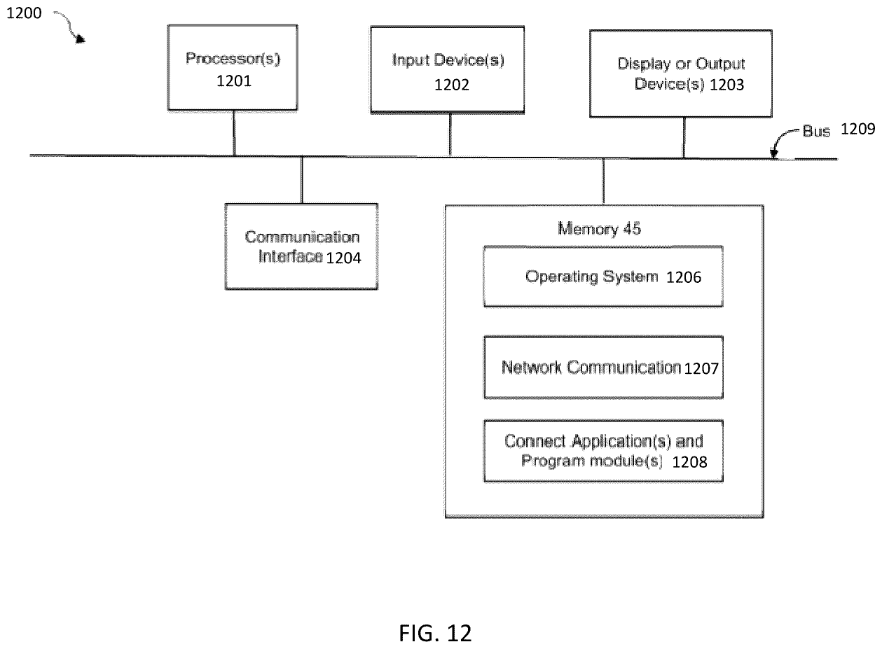

FIG. 11A depicts example code for loading a gesture model and handling an image stream in accordance with some embodiments of the present disclosure. The example code includes a function 1102 to load a trained model for detecting hand gestures. The model can be used to detect hand gestures on a camera stream. The example code requests 1104 permission to access the camera which may prompt the user to allow the application to access the camera. Once the application has access to the camera stream, the stream is analyzed 1106 frame by frame to detect the location of a user's hands and detect the presence one or more gestures.

FIG. 11B depicts example code for identifying a user's hand for gesture recognition in accordance with some embodiments of the present disclosure. Specifically, the example code includes a function 1108 for detecting the user's hands and detecting the presence of one or more gestures (e.g., thumbs up and victory) as part of the analysis 1106 code of FIG. 11A.

In certain embodiments, the connect system may further facilitate connections when the second user did not receive (e.g., notice) the initiating physical gesture from the first user (e.g., an overlooked connection). The connect system can be configured to send a notification to one or more user's based on a potential overlooked connection. In some embodiments, the connect system can be configured to automatically qualify a post as an overlooked connection. For example, a post that goes unsearched and/or is not responded to within a time period may prompt an overlooked connection notification. In alternative embodiments, a posting user may provide input suggesting that the post was associated with an overlooked connection (i.e., the other user did not see them produce the physical gesture).

In certain embodiments, the connect system may automatically select one or more users to receive an overlooked connection notification. The selection may be based on a set of rules. For example, the connect system may limit the selection of users based on geofencing (e.g., based on live tracking information, trends in previous tracking information, and/or user provide location information). The rules can additionally or alternatively limit users based on other information provided the system (e.g., physical descriptions of the user in the post or orientation preferences).

A user may be able to configure the types of notifications received. For example, a user may choose to enable push notifications for communications with other users, but only receive notifications associated with overlooked connections within the application. In some embodiments, notifications associated with overlooked connections may be disabled.

FIG. 12 is a block diagram of an example computing device 1200 that may be utilized to execute embodiments to implement processes including various features and functional operations as described herein. For example, computing device 1200 may function as application server 10, computing devices 20 or combination thereof in some embodiments. The computing device 1200 may be implemented on any electronic device to execute software applications derived from program instructions for the connect application/system 122 of FIG. 1. The computing device 1200 may include but is not limited to personal computers, servers, smart phones, media players, electronic tablets, game consoles, mobile devices, email devices, etc. In some implementations, the computing device 1200 may include one or more processors 1201, one or more input devices 1202, one or more display or output devices 1203, one or more communication interfaces 1204, and memory 1205. Each of these components may be coupled by bus 1209, or in the case of distributed computer systems, one or more of these components may be located remotely and accessed via a network.

Processor(s) 1201 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more non-transitory computer-readable storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASIC s (application-specific integrated circuits).

Input device 1202 may be any known input device technology, including but not limited to a keyboard (including a virtual keyboard), mouse, track ball, and touch-sensitive pad or display. To provide for interaction with a user, the features and functional operations described in the disclosed embodiments may be implemented on a computer having a display device 1203 such as a CRT (cathode ray tube) or LCD (liquid crystal display) monitor for displaying information to the user and a keyboard and a pointing device such as a mouse or a trackball by which the user can provide input to the computer. Display device 1203 may be any known display technology, including but not limited to display devices using Liquid Crystal Display (LCD) or Light Emitting Diode (LED) technology.

Communication interfaces 1204 may be configured to enable computing device 1200 to communicate with other computing or network device across a network, such as via a wired connection, a wireless connection, or a combination of wired and wireless connections. For example, communication interfaces 1204 may include an Ethernet interface, an optical interface, a coaxial interface, an infrared interface, a radio frequency (RF) interface, a universal serial bus (USB) interface, a Wi-Fi interface, a cellular network interface, or the like.

Memory 1205 may be any computer-readable medium that participates in providing computer program instructions and data to processor(s) 1201 for execution, including without limitation, non-volatile storage media (e.g., optical disks, magnetic disks, flash drives, etc.), or volatile storage media (e.g., SDRAM, ROM, etc.). Memory 1205 may include various non-transitory computer-readable instructions for implementing an operating system 1206 (e.g., Mac OS®, Windows®, Linux), network communication 1207, and application(s) and program modules 1208, etc. one program module may be a connect system. The operating system may be multi-user, multiprocessing, multitasking, multithreading, real-time, and the like. The operating system may perform basic tasks, including but not limited to: recognizing input from input device 1202; sending output to display device 1203; keeping track of files and directories on memory 1205; controlling peripheral devices (e.g., disk drives, printers, etc.) which can be controlled directly or through an I/O controller; and managing traffic on bus 1209. Bus 1209 may be any known internal or external bus technology, including but not limited to ISA, EISA, PCI, PCI Express, NuBus, USB, Serial ATA or FireWire.

Network communications instructions 1207 may establish and maintain network connections (e.g., software applications for implementing communication protocols, such as TCP/IP, HTTP, Ethernet, telephony, etc.).

Application(s) and program modules 1208 may include software application(s) and different functional program modules which may be executed by processor(s) 1201 to implement the processes described herein and/or other processes. The program modules may include but not limited to software programs, objects, components, data structures that may be configured to perform particular tasks or implement particular data types. The processes described herein may also be implemented in operating system 1206.

Communication between various network and computing devices may be facilitated by one or more application programming interfaces (APIs). APIs of system 1200 may be proprietary and/or may be examples available to those of ordinary skill in the art such as Amazon® Web Services (AWS) APIs or the like. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call.

The features and functional operations described in the disclosed embodiments may be implemented in one or more computer programs that may be executable on a programmable system including at least one programmable processor coupled to receive data and instructions from, and to transmit data and instructions to, a data storage system, at least one input device, and at least one output device. A computer program may be a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

The described features and functional operations described in the disclosed embodiments may be implemented in a computer system that includes a back-end component, such as a data server, or that includes a middleware component, such as an application server or an Internet server, or that includes a front-end component, such as a user computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include user computing devices and application servers. A user or client computing device and server may generally be remote from each other and may typically interact through a network. The relationship of client computing devices and server may arise by virtue of computer programs running on the respective computers and having a client-server relationship to each other.

### Additional Embodiments

In some embodiments, a computing system includes a server in communication with a first computing device and a second computing device over a network, the server including a processor and a memory storage device storing connect application user information and executable instructions. The executable instruction cause the processor to perform operations including receiving, over a network, authentication information from the first computing device, wherein the authentication information comprises a physical gesture, analyzing the physical gesture to authenticate a first user, receiving, over a network, a connect request from the first computing device operated by the first user, wherein the connect request comprises: an encounter description, a first user location, and time information relating to when the first user was in proximity to a second user, receiving, over the network, a connect request inquiry from the second computing device operated by the second user, the connect request inquiry comprising: a second user location and time information relating to when the first user was in proximity to the second user, and information indicating that a second user requests information about the connect request, and responsive to receiving the connect request inquiry, enabling the second user to view the connect request from the first user.

In some embodiments, the instructions that cause the processor to perform operations further include receiving, over the network, a selection of the connect request from the second computing device; and transmitting, over the network, a notification of the selection to the first computing device.

In some embodiments, the instructions that cause the processor to perform operations further include enabling the first computing device to access user information associated with the second user.

In some embodiments, the instructions that cause the processor to perform operations further include receiving, over the network, a confirmation from the first computing device, in response to the notification; and enabling the second computing device to access user information associated with the first user.

In some embodiments, the instructions that cause the processor to perform operations further include enabling communication between the first computing device and the second computing device.

In some embodiments, the instructions that cause the processor to perform operations further include automatically removing the connect request.

In some embodiments, the instructions that cause the processor to perform operations further include automatically identifying at least one of the first user location and the second user location based on the Global Positioning System (GPS) location of the first computing device and second computing device, respectively.

In some embodiments, the instructions that cause the processor to perform operations further include receiving, over the network, input identifying the first user location from the first computing device.

In some embodiments, the input is provided geographical map-based user interface.

In some embodiments, the physical gesture comprises bringing an index finger and a middle finger together.

In some embodiments, receiving a selection further includes transmitting, over the network, a plurality of connect requests including the connect request associated with the second user location and the time information relating to when the first user was in proximity to the second user, to the second computing device.

In some embodiments, the second user location is within a threshold distance from the first user location.

In some embodiments, enabling the second user to view the connect request from the first user further includes enabling the second user to view a generalized first user location.

In some embodiments, enabling the second user to view the connect request from the first user further includes enabling the second user to view an avatar associated with the first user.

In some embodiments, enabling the second user to view the connect request from the first user further includes enabling the second user to view a photo associated with the first user.

In some embodiments, a computer-implement method includes receiving, over a network, authentication information from a first computing device, wherein the authentication information comprises a physical gesture; analyzing the physical gesture to authenticate a first user; receiving, over a network, a connect request from the first computing device operated by the first user, wherein the connect request comprises: an encounter description, a first user location, and time information relating to when the first user was in proximity to a second user; receiving, over the network, a connect request inquiry from a second computing device operated by the second user, the connect request inquiry comprising: a second user location and time information relating to when the first user was in proximity to the second user, and information indicating that a second user requests information about the connect request; and responsive to receiving the connect request inquiry, enabling the second user to view the connect request from the first user.

In some embodiments, the computer-implement method further includes receiving, over the network, a selection of the connect request from the second computing device; and transmitting, over the network, a notification of the selection to the first computing device.

In some embodiments, the computer-implement method further includes enabling the first computing device to access user information associated with the second user.

In some embodiments, the computer-implement method further includes receiving, over the network, a confirmation from the first computing device, in response to the notification; and enabling the second computing device to access user information associated with the first user.

In some embodiments, the computer-implement method further includes enabling communication between the first computing device and the second computing device.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Accordingly, other implementations are within the scope of the following claims. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter. For example, the steps and/or limitations in the specification, drawings, and/or claims may be performed in an order other than the order set forth in the specification, drawings, and/or claims.

In addition, it should be understood that any figures which highlight the functionality and advantages are presented for example purposes only. The disclosed methodology and system are each sufficiently flexible and configurable such that they may be utilized in ways other than that shown. For example, other steps may be provided, or steps may be eliminated, from the described flows, and other components may be added to, or removed from, the described systems.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

We claim:

1. A computing system, comprising:
a server in communication with a first computing device and a second computing device over a network, the server comprising:
a processor; and
a memory storage device storing connect application user information and executable instructions that cause the processor to perform operations comprising:
receiving, over a network, authentication information from the first computing device;
authenticating a first user;
receiving, over a network, a connect request from the first computing device operated by the first user; and
receiving, over the network, a connect request inquiry from the second computing device operated by the second user.
